(19) United States
(12) Patent Application Publication
(10) Pub. No.: US 2019/0286068 A1
(43) Pub. Date: Sep. 19, 2019

(54) WRIST-WORN WATCH DEVICE INCLUDING POWER RESERVE FOR PORTABLE ELECTRONIC DEVICES

(71) Applicant: SCINEX INC., Sunrise, FL (US)

(72) Inventor: Ronny Nadav Helled, Plantation, FL (US)

(21) Appl. No.: 15/923,914

(22) Filed: Mar. 16, 2018

(51) Int. Cl. G04G 17/06; G04G 21/00

(52) U.S. Cl. CPC G04G 17/06; G04G 19/10; G04G 21/00

(57) ABSTRACT

A wrist-worn watch device includes a time keeping circuit that is powered by a first battery disposed in the body of the watch device. A larger, secondary battery is also disposed in the body of the watch device. The secondary battery is not used to power the time keeping circuit, but rather can be recharged through a connector disposed on a first wrist strap portion, and can be used to recharge the battery of a portable electronic device through a connector on the second wrist strap portion.

### FIELD OF THE INVENTION

The present invention relates generally to portable electronic devices, and, more particularly, relates to a wrist-worn time keeping device including

### BACKGROUND OF THE INVENTION

In the last decade “smart phone” devices have become increasingly common. These devices, in addition to providing cellular telephony functionality, also operate substantially as a general purpose computing device that can run application programs, store data, acquire and play media files, and many other tasks. Accordingly it is common for people to carry the phone device with them most of the time. Since these devices are powered by rechargeable batteries, it is not unusual for the battery charge to get low at times and places where there isn't access to a way to recharge the phone battery.

One way this problem has been addressed is with a portable “power pack,” which is a device that includes, typically, a large capacity rechargeable battery that can be used to recharge a phone battery or provide power to other portable devices. However these portable battery packs tend to be bulky, and inconvenient to carry. Since they serve no other purpose, it is not uncommon for a person to forget to bring their portable battery back when they go somewhere. Sometimes a person may plan to not be away for very long, and end up being away longer a expected, without having a way to recharge their phone battery.

Therefore, a need exists to overcome the problems with the prior art as discussed above.

### SUMMARY OF THE INVENTION

The invention provides a wrist-worn watch device including power reserve for portable electronic devices that overcomes the hereinafore-mentioned disadvantages of the heretofore-known devices and methods of this general type and that are capable of providing power to recharge a battery of a portable electronic device such as a cellular telephone device.

With the foregoing and other objects in view, there is provided, in accordance with the invention, a wrist-worn watch device that includes a body. The body has an internal volume and an external face on which a visual time keeping indicator disposed. The time indicator is controlled by a time keeping circuit that is also disposed in the internal volume of the body. A primary battery is also disposed in the internal volume of the body that exclusively powers the time keeping circuit. A secondary battery is also disposed in the internal volume of the body, with a non-volatile memory. The non-volatile memory is a machine readable storage memory device. The watch device further includes a first wrist strap portion that is coupled to the body at a proximal end of the first wrist strap portion by a first coupling. The first wrist strap portion includes a first electrical connector having a first mechanical arrangement that is disposed at a distal end of the first wrist strap portion, and that is electrically connected to the non-volatile memory and the secondary battery through the first coupling. The watch device further includes a second wrist strap portion that is coupled to the body at a proximal end of the second wrist strap portion by a second coupling. The second wrist strap portion includes a second electrical connector having a second mechanical arrangement that is disposed at a distal end of the second wrist strap portion and that is electrically connected to the non-volatile memory and the secondary battery through the second coupling.

In accordance with another feature, an embodiment of the present invention includes a pair of retaining pins extending perpendicularly from the first wrist strap portion at the distal end on an inward-facing side of the first wrist strap portion. The watch device can further include the second wrist strap portion having a plurality of retaining holes arranged along a length of the second wrist strap portion configured to receive and retain the pair of retaining pins at an outward-facing surface of the second wrist strap portion.

In accordance with another feature, an embodiment of the present invention includes the first connector being configured as a micro-USB B-plug connector.

In accordance with another feature, an embodiment of the present invention includes the first connector and second connector having different mechanical and electrical arrangements.

In accordance with another feature, an embodiment of the present invention provides that the non-volatile memory comprises removable memory card.

In accordance with another feature, an embodiment of the present invention provides a solar power source that provides electric power only to the time keeping circuit and primary battery.

In accordance with another feature, an embodiment of the present invention provides that the first coupling comprises a first protrusion at a first end of the body that fits within a cavity formed by a first support member at the proximal end of the first wrist strap portion, and the second coupling comprises a second protrusion at a second end of the body that fits within a cavity formed by a second support member at the proximal end of the second wrist strap portion.

In accordance with another feature, an embodiment of the present invention provides that the plurality of electrical contacts are disposed at a bottom of each of the first and second protrusions at the first and second ends, respectively of the body, and that the plurality of contacts of the first protrusion mate with a corresponding contact on an end of the first wrist strap portion and the plurality of contacts of the second protrusion each mate with corresponding contact on an end of the second wrist strap portion.

Although the invention is illustrated and described herein as embodied in a wrist-worn watch device including power reserve for portable electronic devices, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Those skilled in the art can understand the specific meanings of the above-mentioned terms in the embodiments of the present invention according to the specific circumstances

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is schematic block diagram of a watch device, in accordance with some embodiments;

FIG. 2 is side exploded view of a watch device, in accordance with some embodiments;

FIG. 3 is a top plan view of a body of a watch device, in accordance with some embodiments;

FIG. 4 is a side elevational view of the body of a watch device where a wrist strap portion connects to the body, in accordance with some embodiments;

FIG. 5 is bottom view of a first wrist strap portion, in accordance with some embodiments;

FIG. 6 is a top view of a second wrist strap portion, in accordance with some embodiments;

FIG. 7A is side view of an end of a wrist strap portion that connects to the body of a watch device, in accordance with some embodiments;

FIG. 7B is a bottom view of an end of a wrist strap portion that connects to the a portable electronic device to recharge a battery of the portable electronic device, in accordance with some embodiments;

FIG. 8A is a system diagram showing a watch device connected to a computing device, in accordance with some embodiments;

FIG. 8B is a system diagram showing a watch device connected to a portable electronic device, in accordance with some embodiments;

FIG. 9 is a flow chart diagram of a method for charging a secondary battery in a watch device, in accordance with some embodiments;

FIG. 10 is a flow chart diagram of a method for charging the battery of a portable electronic device from the secondary battery of a watch device, in accordance with some embodiments;

FIG. 11 is an exploded perspective view of a wrist watch device, in accordance with some embodiments; FIGS. 12A & 12B show side profiles of a wrist strap portion having an electrical connector, in accordance with some embodiments;

FIG. 13 shows an exploded side view of a wrist watch device showing how the wrist strap portions attach to the body of the wrist watch device, in accordance with some embodiments; and

FIG. 14 shows a side view of a wrist watch device that shows how the wrist strap portions are retained when worn by a user, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

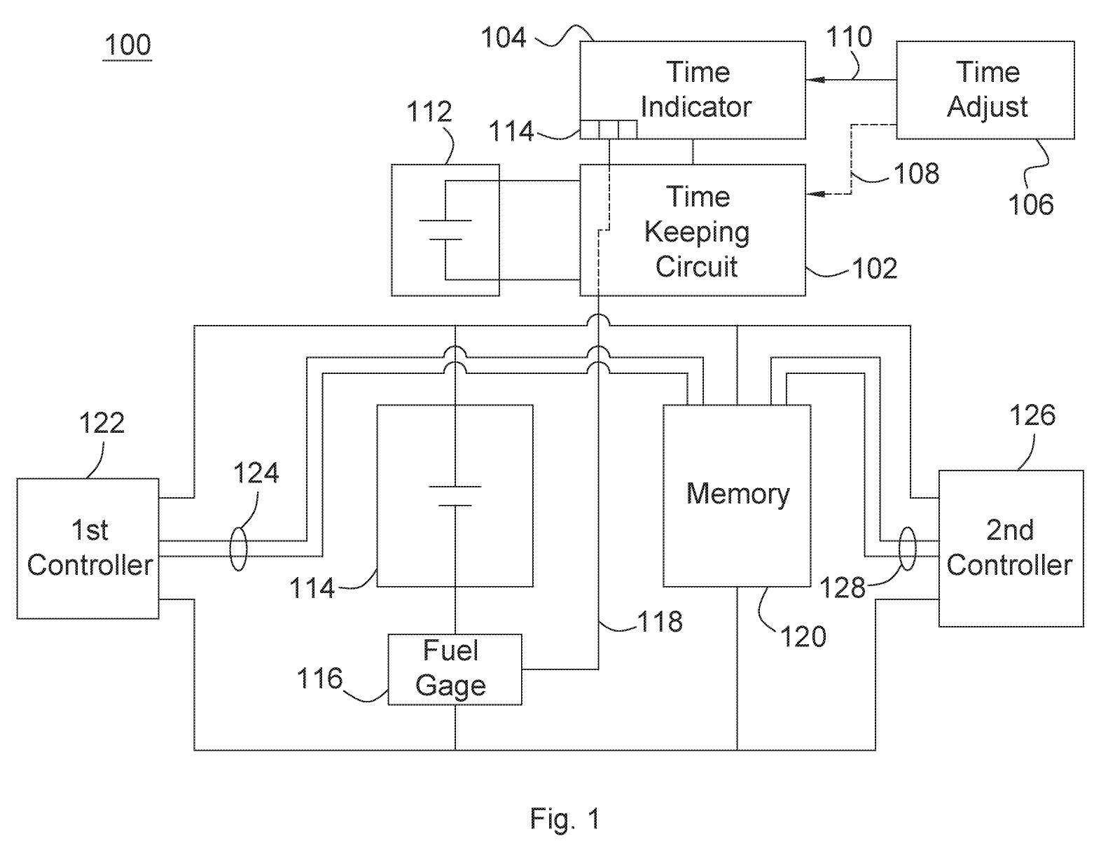

The present invention provides a novel and efficient wrist watch device that include a power source that can be charged, and subsequently used to recharge the batter of a portable electronic device. Referring now to FIG. 1, there is shown a schematic block diagram of a watch device 100, in accordance with some embodiments. In general the watch device includes, in addition to a time keeping system, a reserve battery that is not used to power the time keeping system, and is instead used to recharge or otherwise provide power to a portable, battery powered device, such as a cellular telephone device. As such, the reserve battery is disposed inside a body of the watch device, and can itself be recharged from an external source. Furthermore, the watch device can include data storage capability to store data that can be access by the portable electronic device. For example, picture files can be transferred from the portable electronic device to the watch device, which can then be used to transfer the picture files to a general computing device.

Accordingly, the watch device can include a time keeping circuit 102, which is a mechanical, electrical, or electromechanical time keeping system that is commonly referred to as a “movement.” The time keeping circuit includes a time regulator that control the measurement of the passage of time. The time keeping circuit controls a time indicator 104, which can be any known time indicator system, include a liquid crystal display, hands (e.g. hour and minute hands), or a combination. The time indictor can be adjusted by a time adjust assembly, which can directly move the tune indicator as indicated by line 110, or cause the time keeping circuit to move the time indictor as indicated by line 108. In general, the time indicator indicates a time of day, and can further include date, and other functions, as provided by the time keeping circuit 102. The time keeping circuit, if it is electrically operated, can be power by a primary battery 112, which can be a single non-rechargeable electrochemical cell. In some embodiments, the time keeping circuit can be mechanically driven, obviating the need for the primary battery 112. In some embodiments, battery 112 can be a rechargeable battery, and the watch device 100 can further include a solar power source 113 that provides electric energy to the battery 112. The solar power source can include, for example, a light sensitive material that can be disposed on an exposed surface of the watch device, such as on the watch face. The light sensitive material produces electricity, as is well known, upon being exposed to light.

The watch device 100 further includes a secondary battery 114 that includes one or more rechargeable cells. In some embodiments a fuel gauge circuit 116 can be connected in series with the secondary battery 114 to track how much charge is in the secondary battery 114. An example of a fuel gauge circuit is sold by Maxim integrated under the designation DS2782, and can provide an output that indicates the state of charge of the secondary battery 114 on a data line 118. The information provided on data line 118 can be used to control a charge indicator 119 on the face of the watch device 100 along with the time indicator system 104. For example, a three segment liquid crystal display can be used to indicate several level of approximal battery charge. In other embodiments and more detailed indication can be given, such as, for example, a percentage (e.g. 0%-100%). The information on line 118 can be accessed by the time keeping circuit 102 or act directly on the charge indicator 119. The secondary battery 114 is further connected to both a first connector circuit 122 and a second connector circuit 126. The first and second connector circuits 122, 126, each include a mechanical connector for electrically interfacing with another device, along with any necessary circuitry. Circuity in the connector circuits 122, 126 can protect against, for example, electrostatic discharge, provide signal conditioning, and so on. The first connector circuit 122 include a female connector, such as a female Universal Serial Bus (USB) micro-B connector. A female USB micro-B connector is common for receiving a mating male connector coupled to a power source and/or computing device. Female USB micro-B connectors are commonly used on cellular telephone devices to receive electrical power to recharge a battery as well as provide access to the memory in the cellular telephone device. The male connector of the second connector circuit 126 can be a male USB micro-B connector, or another male connector such as, for example, that developed by Apple, Inc. under the trade name “Lighting.” Furthermore, the male connector of the second connector circuit 126 is extendible, meaning it can be moved between a retracted position when not in use, and an extended position for connecting to a corresponding female connector.

The first and second connector circuits 122, 126 can be further connected to a memory device 120, such as, for example, a flash memory card that can be mounted in a “slot” connector in the body of the watch device. Data lines 124 connect the first connector circuit 122 to the memory device 120, as lines 128 connect the memory device to the second connector circuit 26. Thus, the memory device can be accessed from both the first and second connector circuits 122. 126.

In general, the first connector circuit 122 connects to a device that provides power to the secondary battery 114 to recharge the secondary battery 114. If the device connected to the first connector circuit 122 is a computing device, then it can access the memory in the memory device 120 as well. The secondary connector circuit 126 is designed to connect to a portable electronic device that has a rechargeable battery that can be recharged by the secondary battery 114.

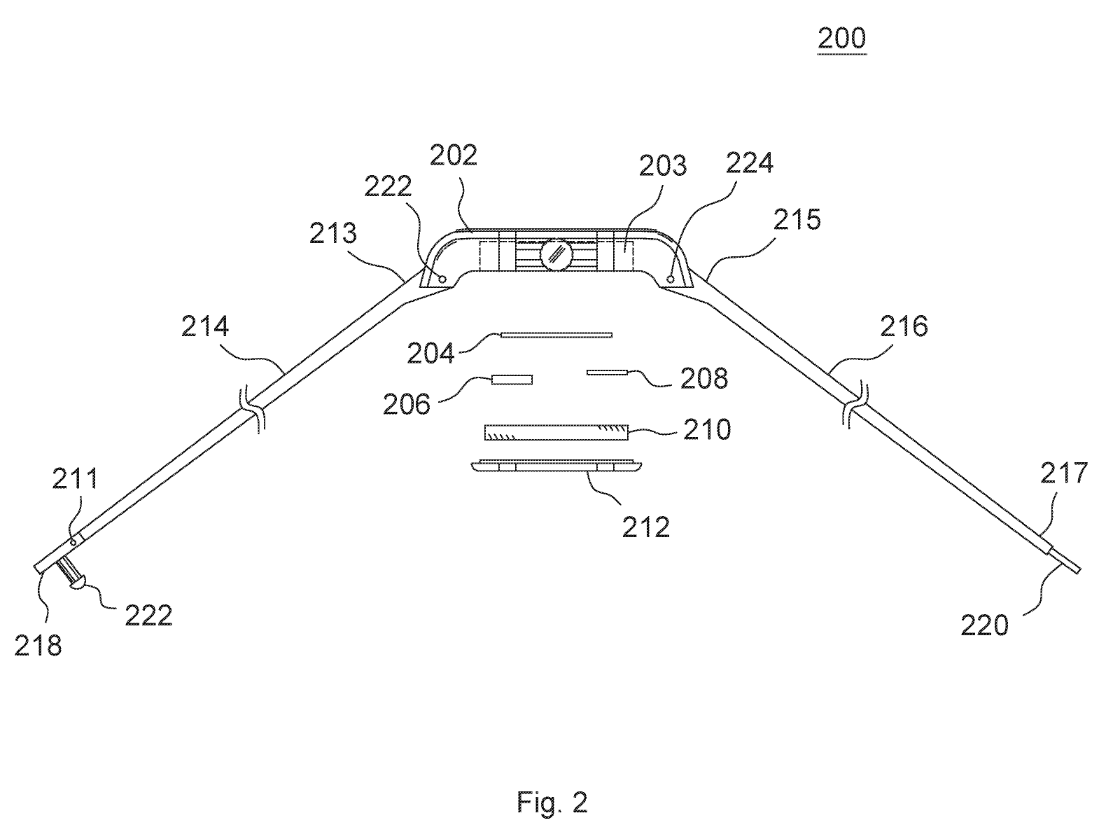

FIG. 2 is side exploded view of a watch device 200, in accordance with some embodiments. The watch device 200 includes a body 202, a first wrist strap portion 214, and a second wrist strap portion 216. The first and second wrist strap portions 214, 216 are each connected to the body and extend away from the body. The body includes a face, viewable from the top (not seen in this view), on which a time indicator is provided to indicate the time. The body defines an internal volume 203 in which is disposed a time keeping circuit 204, and a primary battery 206 for powering the time keeping circuit 204. The time keeping circuit 204 can be an electrical or electromechanical circuit that is designed to constantly adjust the time indicator to indicate the time. Further disposed in the internal volume of the body 202 is a memory device 208, such as a micro-SD flash memory card. The memory device can be mounted on a circuit board that also includes circuitry for the time keeping circuit 204, or on a separate substrate or connector. The secondary battery 210 is also disposed within the internal volume 203, along with any circuitry (e.g. fuel gauge circuitry) that may be associated with the secondary battery. A cover 212 attaches to the back/bottom of the body, opposite the face, to seal the internal volume 203 with the time keeping circuit 204, primary battery 206, memory device 208, and secondary battery 210 inside.

The watch device 200 further includes a first wrist strap portion 214 and a second wrist strap portion 216, each having a proximal end 213, 215, respectively, coupled to the body 202 of the watch device 200. At a distal end 211 of the first wrist strap portion 214 is first connector 218 that can be, for example, a female connector such as a female USB micro-B connector. The first connector 218 can be oriented such that a male connector is inserted into the first connector 218 generally in line with the length of the first wrist strap portion 214, which is the line between the proximal 213 and distal end 211 when the first wrist strap portion 214 is flat. Similarly, the second wrist strap portion 216 includes a second connector 220 that can be a male electrical connector. The second connector can be moveable between a retracted position inside the distal end 217 of the second wrist strap 216, and an extended position where the connector extends beyond the distal end 217 of the second wrist strap portion 216. Each of the first and second connectors 218, 220 can include connector circuitry disposed inside the respective wrist strap portions 214, 216. Further, the first and second connectors 218, 220 are electrically connected by conductor elements through the respective wrist strap portions 214, 216 from the distal ends 211, 217 to the proximal ends 213, 215 to connectors that pass through the sides of the body 202 to electrically connect with the elements inside the internal volume 203. The wrist strap portions 214, 216 can be retained on the body 202 by screws 222, 224, respectively, that pass through a transverse channel in the proximal end of each wrist strap portion, and extend into holes on opposing features that protrude from the body 202.

The first wrist strap portion can further include a pair of posts or prongs 222 that extend from the side of the first wrist strap 214 that faces the wearer's wrist at or near the distal end 211. The prongs 222 mate with, and are retained by holes formed through the second wrist strap portion 216 by friction or mechanical interference. By pushing the prongs 222 through a set of the holes in the second wrist strap portion 216, the watch device 200 can be worn on a user's wrist. This arrangement of fastening the wrist strap portions 214, 216 together allows clearance for the first and second connectors 218, 220 to connect to other devices.

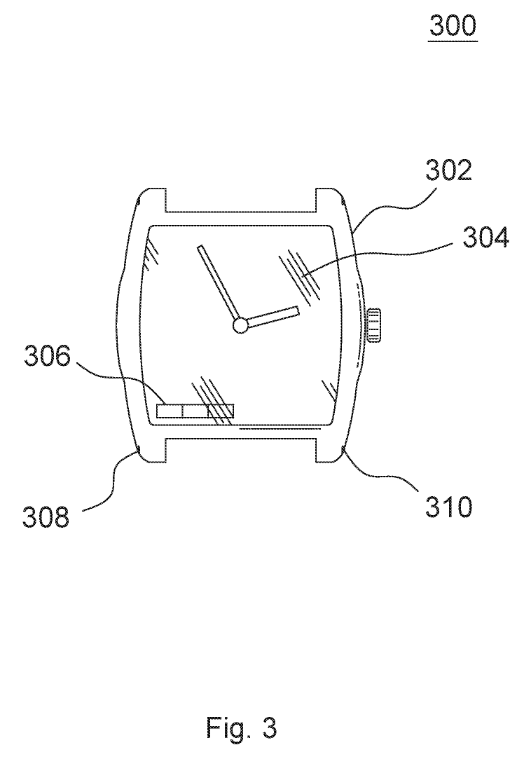

FIG. 3 is a top plan view 300 of a body 302 of a watch device, in accordance with some embodiments. The view 300 shows the face of the watch device on the body, without the wrist strap portions present. On the face is a time indicator, such as a conventional hour hand and minute hand. The time indicator can also be embodied as a liquid crystal display, or a combination of mechanical hands and LCD segments. The time indicator components are controlled and operated by the time keeping circuit inside the watch body, and can be adjusted conventionally. In some embodiments it is further contemplated that a battery charge indicator 306 can be provided on the face of the watch device. The charge indicator 306 indicates an approximate charge status of the secondary battery inside the watch body 302 to allow a user to determine whether the secondary battery needs to be recharged, as well as an indication as to how much more the battery of another device, such as a cellular telephone device, can be recharged from the secondary battery. Further, at each end of the body 302, there are two opposing lugs, such as lugs 308, 310 that extend or protrude from the body 302 for retaining a wrist strap portion.

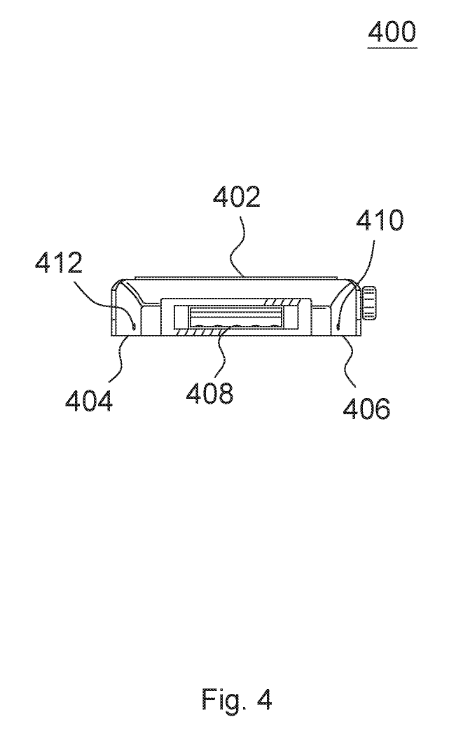

FIG. 4 is a side elevational view 400 of the body 402 of a watch device, showing the location where a wrist strap portion connects to the body 402, in accordance with some embodiments. The body 402 can include a pair of opposing lugs 404, 406 which extend outward from the body and define a space between them in which the proximal end of a wrist strap portion is received. In each lug 404, 406 there is a lug hole, 412, 410, respectively in which screws can be placed to retain the wrist strap portion. Alternatively, pins can be used in some embodiments, as is conventional. Further, in some embodiments, there can be an electrical connector 408 that mates with a corresponding connector in the proximal end of the wrist strap portion. The electrical connector 408 can allow electrical current and signals to connect to components inside the body 402, such as the secondary battery and a memory device. The electrical connector 408 can be accessed through an opening in the body 402, and resides within the body 402 without protruding into the space between the lugs 404, 406. However, as shown here, the connector 408 is a female connector that receives a male connector from a wrist strap portion. Those skilled in the art will appreciate that the connector 408 can equivalently be a male connector that extends from the body 402 to mate with a corresponding female connector in the wrist strap portion.

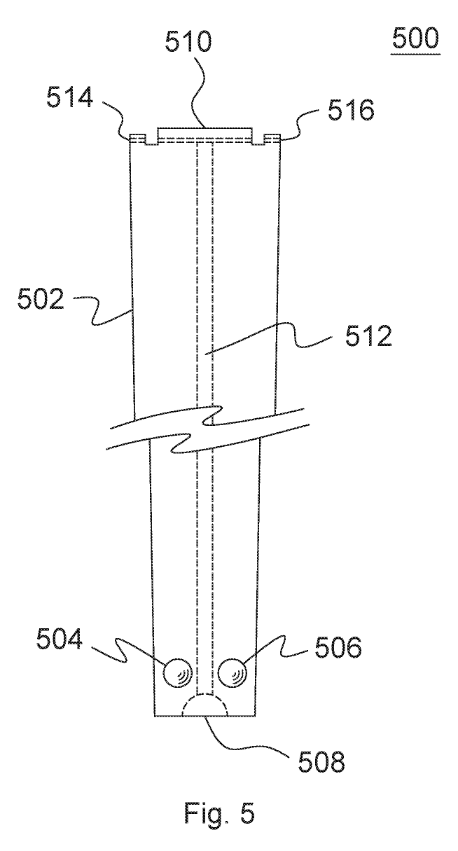

FIG. 5 is bottom view of a first wrist strap portion 500, in accordance with some embodiments. The first wrist strap portion 500 include a flat strap portion 502. At a distal end there are a pair of prongs 504, 506 extend from the surface (e.g. equivalent to prongs 222 of FIG. 20 out of the page, as shown in the view of FIG. 5. At the terminus of the distal end, embedded in the distal end, is a first connector 508, which can be, for example, a female USB micro-B connector. Conductors 512 run from the first connector 508 to a body connector 510 at the proximal end of the wrist strap portion 500. The body connector can mate with a corresponding connector in the body of the watch device (e.g. connector 408 of FIG. 4). Thus, a device connected to the first connector 508 can electrically access components inside the body of the watch device, allowing charging of the secondary battery, as well as access to a memory device. Two extensions 514, 516 are size to fit between the lugs at one end of the watch body, and receive a retaining pin to retain the wrist strap portion to the watch body. Alternatively, the extensions 514, 516 can be ends of a transverse channel through the proximal end of the wrist strap portion to provide more bearing surface against the retaining pin.

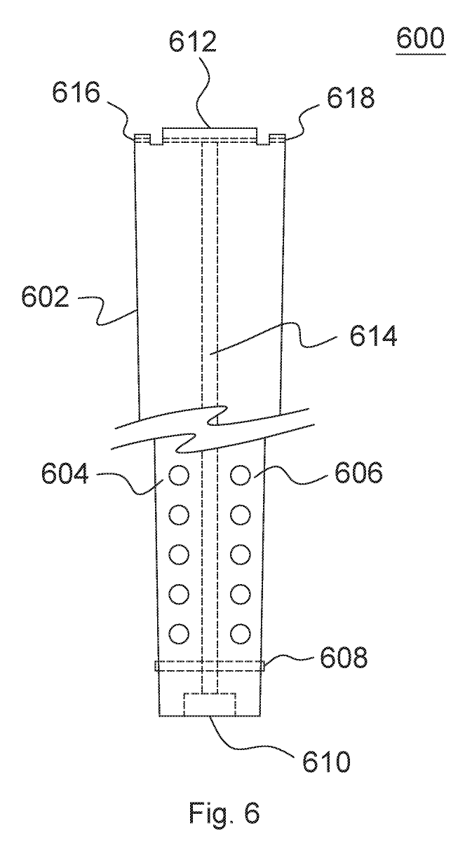

FIG. 6 is a top view of a second wrist strap portion 600, in accordance with some embodiments. Like the first wrist strap portion, the second wrist strap portion 600 includes an elongated flat strap portion 602. The second wrist strap portion also includes columns of holes 604, 606 in pairs that correspond to the prongs (e.g. 504, 506), and which can receive and retain the prongs to hold the watch device onto the wearer's wrist. A retaining loop 6-8 can extend over the wrist strap to retain the portion of the first wrist strap portion that overlaps to connect with the second wrist strap portion 600. A second connector 610 is located at a distal end of the wrist strap portion what can include an extendable male portion. The second connector 610 is electrically coupled to a second body connector 612 via conductors 614 in or on the second wrist strap portion 600. The second body connector 612 mates with a corresponding connector in the body of the watch device (e.g. like 408, but on the opposite side from where the first wrist strap portion connects). Further, a pair of opposing extensions 616, 618, like 514, 516, receive a retaining pin to hold the second wrist strap portions between opposing lugs of the watch body.

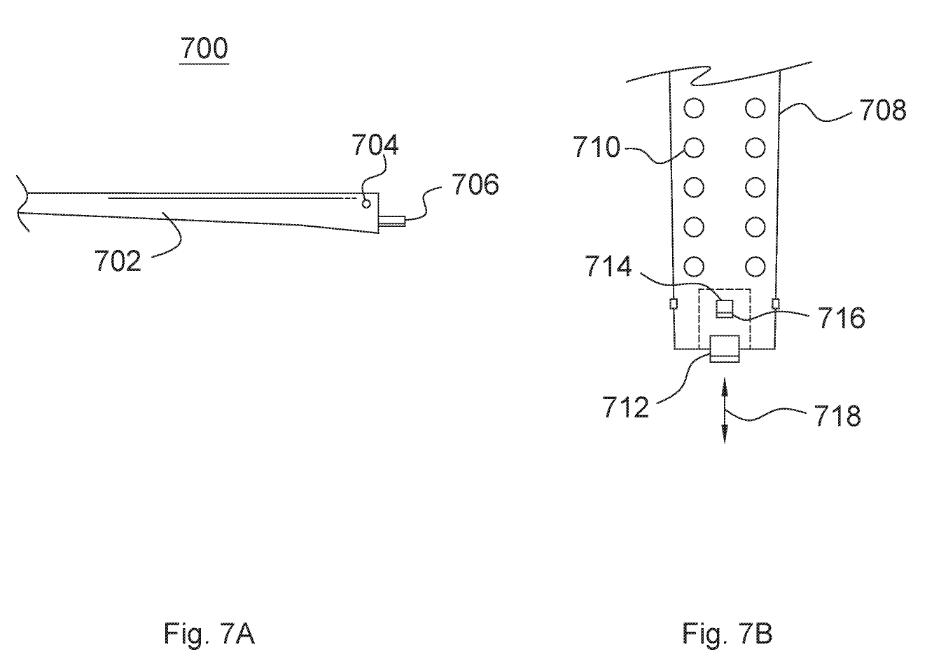

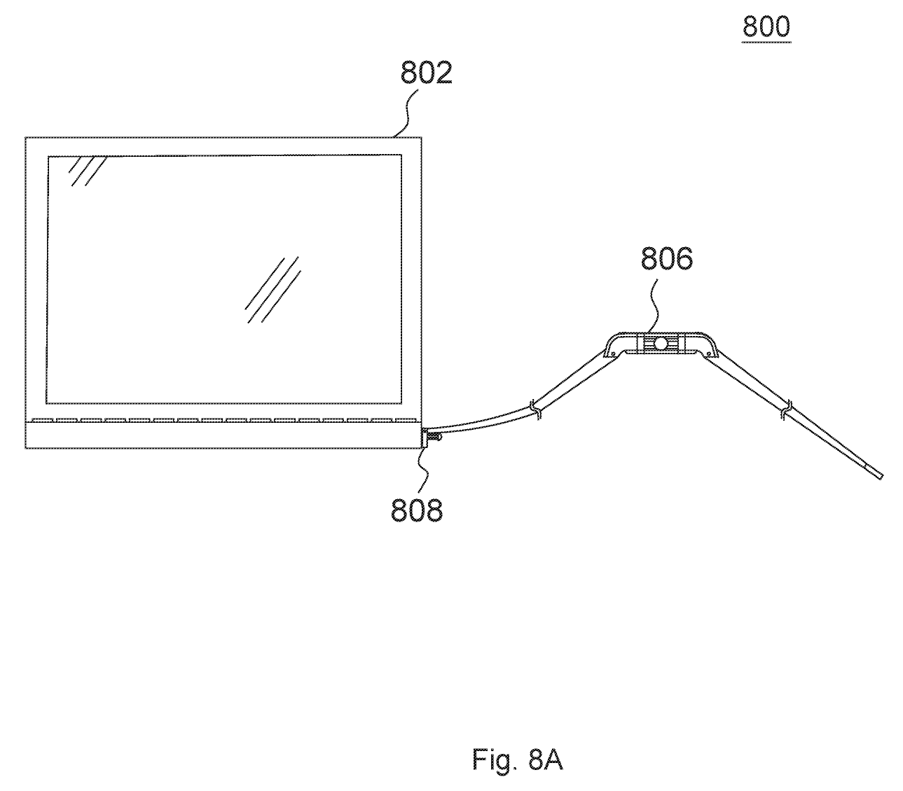

FIG. 7A is side view 700 of an end of a wrist strap portion 702 that connects to the body of a watch device, in accordance with some embodiments. The portion shown here could be the proximal end of either the first or second wrist strap portions as shown in FIGS. 5-6. A retaining hole or channel 704 receives a retaining pin to retain the wrist strap portion between the lugs on the body of the watch device. A body connector 706 extends from the proximal end of the wrist strap portion to mate with a corresponding connector in the body of the watch device. The body connector 706 is electrically connected to a connector at the distal end of the wrist strap portion (e.g. 508 or 610).

FIG. 7B is a bottom view of an end of a second wrist strap portion 708 that connects to the a portable electronic device to recharge a battery of the portable electronic device, in accordance with some embodiments. The view in this illustration shows the side of the second wrist strap portion that will be against the wearer's wrist, normally. The second wrist strap portion 708 includes a plurality of retaining holes 710 that can be arranged in a pair of columns of retaining holes along the length of the second wrist strap portion 708, and that receive and retain the prongs at the distal end of the first wrist strap (e.g. 504, 506). The second connector 712 is located at the distal end and is moveable between a retracted position and an extended position, as indicated by arrow 718. The second connector 712 can be electrically connected with a body connector at the proximal end of the second wrist strap portion (e.g. 612). To move the second connector 712, a lever 716 can protrude from a channel 714 in which the lever 716 is captured. Thus, when not in use, the second connector 712 can be retracted, and when it needs to be used to connect to a device, it can be extended and inserted in into a mating connector of the device.

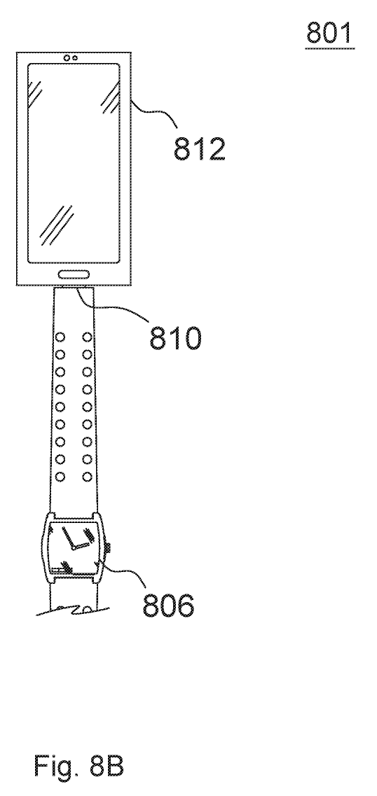

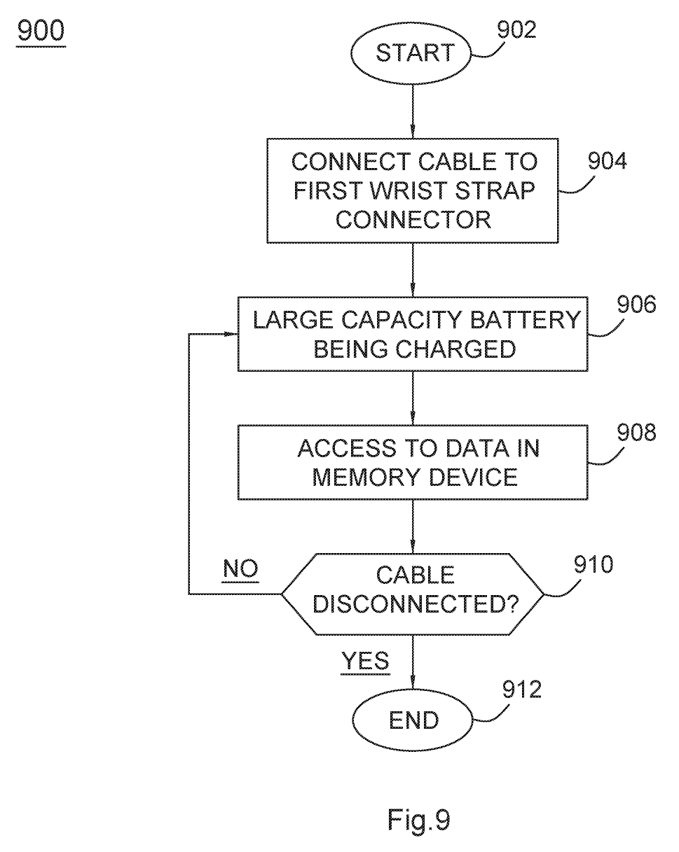

FIGS. 8A and 8B are system diagrams 800, 801 showing a watch device 806 connected to a computing device 802 in FIG. 8A, and a portable electronic device 812 in FIG. 8B, in accordance with some embodiments. The diagram 800, 801 serve to show the connectivity of the watch device 806, and is not intended to necessarily represent the ordinary usage of the watch device 806. The watch device 806 includes a secondary battery disposed in the body of the watch device, and further include first and second wrist strap portions. The first wrist strap portion is connected to the computing device 802 at the first connector 808 at the distal end of the first wrist strap portion. The first connector 808 can be, for example, a USB conenctor that allows power to flow from the computing device 802 to the secondary battery in the watch device 806 to charge the secondary battery (if needed). The computing device can also access a memory device inside the watch device 806, to add, remove, or copy file and other data that can be stored in the memory device. Alternatively, the first connector 808 could be connected to a battery charger instead of the computing device 802, as long as the charger has a mating connector that mates with connector 808.

The watch device 806, via a second connector 810 at the distal end of the second wrist strap, can connect to a portable, battery powered electronic device, such as a cellular telephone device 812. In this arrangement, the secondary battery in the watch device 806 provides charge to the battery of the cellular telephone device 812 so that it can be recharged, or to simply power the cellular telephone device 812. In addition, through an application or interface on the cellular telephone device 812, the user can access the memory in the watch device 806, and add, remove, or copy files and/or other data. to/from the memory in the watch device. In actual usage, the watch device would ordinarily only be connected to either the computing device/charger, or to the cellular telephone device (or similar portable electronic device).

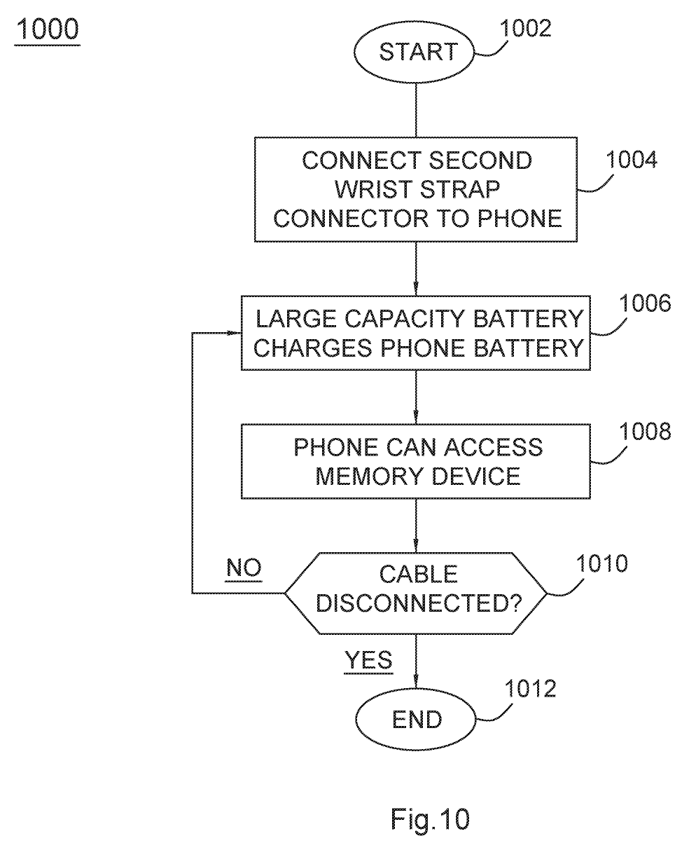

FIG. 9 is a flow chart diagram of a method 900 for charging a secondary battery in a watch device, in accordance with some embodiments. At the start 902 the watch device is operating normally, and the user has a power source to which the user can connect the watch device at the first connector on the first wrist strap portion. The power source can be, for example, a USB charger, a computing device, or any other electrical power source that can provide an appropriate regulated voltage and current suitable to recharge the secondary battery in the watch device. In step 904 the power source is connected by, for example, a cable, to the first connector on the first wrist strap. In step 906 the secondary battery in the watch device is being recharged with electrical power from the power source. In some embodiments a charge status display on the watch device can be updated to reflect the increase of charge in the secondary battery. In step 908 the power source, in cases where the power source is a computing device, can access a memory inside the watch device to add, delete, or otherwise interact with files and data in the memory. For example, if the memory contains image files, those image files can be transferred to the computing device for storage, editing, etc. In step 910 the method 900 continues charging and providing data access until the cable is disconnected from the first connector and the method 900 ends 912.

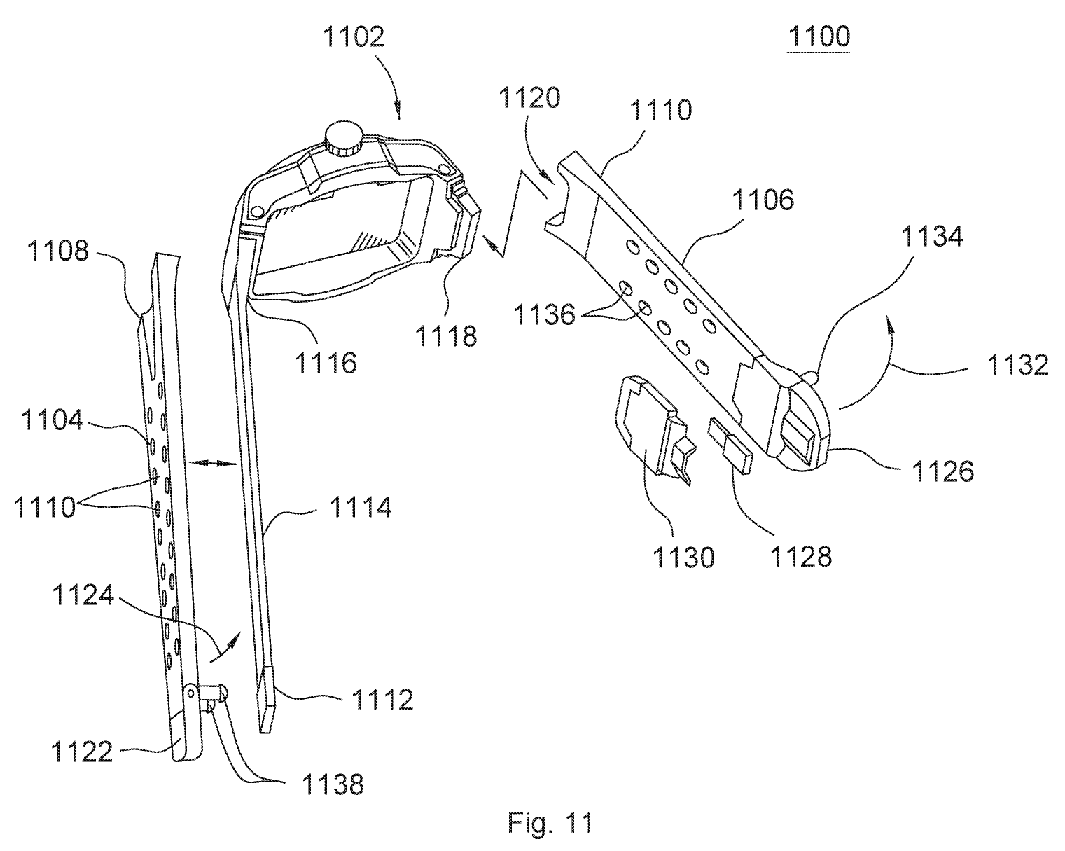

FIG. 10 is a flow chart diagram of a method 1000 for charging the battery of a portable electronic device from the secondary battery of a watch device, in accordance with some embodiments. At the start 1002, the secondary battery of the watch device is charged, at least enough to provide charge to the battery of the portable electronic device. In step 1004 the second connector of the second wrist strap portion can be connected to a corresponding connector on the portable electronic device. The second connector can be initially in a retracted position that the user changes to an extended position so that it can be mated with the corresponding connector of the device being charged. In step 1006 the secondary battery of the watch device provides a charging current and voltage to the battery of the portable electronic device. In step 1008 the portable electronic device can access the memory in the watch device and commence data operations, such as transferring files to the memory, loading files into memory of the portable electronic device, and so on. In step 1010 the method 1000 continues until the second connector is disconnected. The battery of the portable electronic device may become fully charged while the watch device is connected to the portable electronic device, but an occasional maintenance charge current can be provided. When the second connector is disconnected, then the method ends 1012.

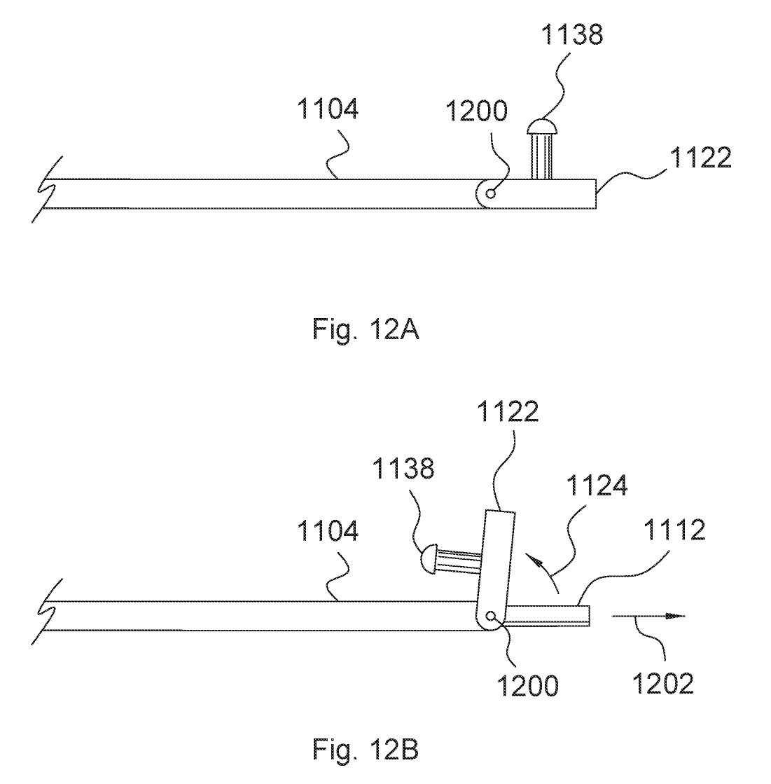

FIG. 11 is an exploded perspective view of a wrist watch device 1100, in accordance with some embodiments. The device 1100 includes a body 1102 in which is disposed a time keeping circuit, a time indicator that is driven by the time keeping circuit, a battery fur powering the time keeping circuit, and a secondary battery unconnected to the time keeping circuit that can be used to provide power to a mobile electronic device. Attached to the body 1102 is a first wrist strap portion 1104 and a second wrist strap portion 1106. Each wrist strap portion 1104, 1106 connects to the body by interfacing with a respective electrical connector. A support member 1108, 1110 is disposed at the proximal end of each wrist strap portion 1104, 1106, respectively. The support members 1108, 1110 hold onto the wrist strap portions 1104, 1106, and provide a coupling to the body 1102, such as by pins or screws, to hold the wrist strap portions 1104, 1106 to the body 1102.

As shown here, the support members 1108, 1110 extend from the proximal end of their respective wrist strap portion 1104, 1106, and are sized and shaped to receive a protruding portion 1116, 1118, respectively, on each end of the body. The protruding portions 1116, 1118 generally point down, and are angle away from a vertical direction, from top to bottom of the body 1102, in opposite directions. At the bottom of each protruding portion 1116, 1118 are several separate electrical contacts that mate with corresponding contacts disposed at the proximal ends of the wrist strap portions 1104, 1106. Thus, for example, protruding portion 1118 fits into cavity 1120 in the second support member 1110.

In the first wrist strap portion 1104, for example, a connector at the proximal end which mates with first protruding portion 1116 is connected to several separate, corresponding conductors 1114 that, while shown here outside of first wrist strap portion 1104, are disposed within wrist strap portion 1104. The conductors 1114 connect corresponding contacts at the proximal end with contacts in a first connector 1112 at the distal end of the first wrist strap portion. The first connector 1112 protrudes from the distal end, generally in the same direction(i.e. not angled) with respect to the wrist strap portion 1104 when the wrist strap portion 1104 is flat/straight. A first cover 1122 can be used to cover and protect the first connector when the first connector is not in use. The first cover is coupled to the distal end of the first wrist strap portion at the opposing sides of the distal end of the first wrist strap portion, and is rotatable about an axis between the points where it is coupled to the distal end of the wrist strap portion 1104, as indicated by arrow 1124. A pair of retaining protrusions 1138 extend from the first cover 1122, and are sized to fit into holes in the second wrist strap portion 1108 to hold the first and second wrist strap portions together about a user's wrist by being inserted into retaining holes 1136. Likewise, the second cover 1126 at the distal end of the second wrist strap portions 1106 includes a pair of retaining protrusions 1134 that are inserted into retaining holes 1140 in the first wrist strap portion 1104 to further hold the two wrist strap portions together.

The second wrist strap portion includes a second connector 1128, shown here separate from the distal end of the second wrist strap portion 1106, but which is assembled into the distal end of the second wrist strap portion 1106. The second connector 1128 includes a plurality of electrical contacts that mate with corresponding contacts in a connector of a portable electronic device. When connected to the portable electronic device, an electrical current can be provided to the portable electronic device from the secondary battery inside the body 1102 to recharge a battery of the portable electronic device or otherwise power the portable electronic device. The second connector 1128 is coupled to conductors that pass through the second wrist strap portion 1106 to the connector at the proximal end of the second wrist strap portion in the second support member 1110 to interface with corresponding contacts at the bottom of the second protrusion 1118.

The second connector 1128 is protected by a cover 1126 that, like cover 1122, is rotatable in the direction of arrow 1132. Thus, the second connector 1128 can be exposed for connecting it to the portable electronic device by rotating the cover 1126 to expose the second connector 1128. A bottom portion 1130 can couple to the cover 1126 to further protect the second connector 1128 when the second connector 1128 is not being used to connect to a portable electronic device.

FIGS. 12A & 12B show side profiles of the first wrist strap portion 1104 of FIG. 11, having a first electrical connector 1112, in accordance with some embodiments. In FIG. 12A, the cover 1122 is positioned to cover and protect the first electrical connector 1112. The first cover 1122 can be attached to the distal end of the first wrist strap portion 1104 at the sides of the distal end of the first wrist strap portion 1104, such as by a screw or pin 1200. In FIG. 12B, the cover 1122 is rotated in the direction of arrow 1124 to expose the first connector 1112. Thereafter, the first wrist strap portion 1104 can moved in the direction of arrow 1202 to connect with a mating connector, such as a USB connector. The first electrical connector 1112 is used to recharge the secondary battery in the watch device, and can also provide access to a memory device in the watch device. The second connector 1128 on the second wrist strap portion 1106 is accessed similar, by rotating cover 1126 to expose the second connector 1128 so that is can be coupled to a mating connector in a portable electronic device. However, the second connector 1128 provides power from the secondary battery in the body of the watch device, whereas the first connector 1112 is used to provide power to the secondary battery in the body of the watch device.

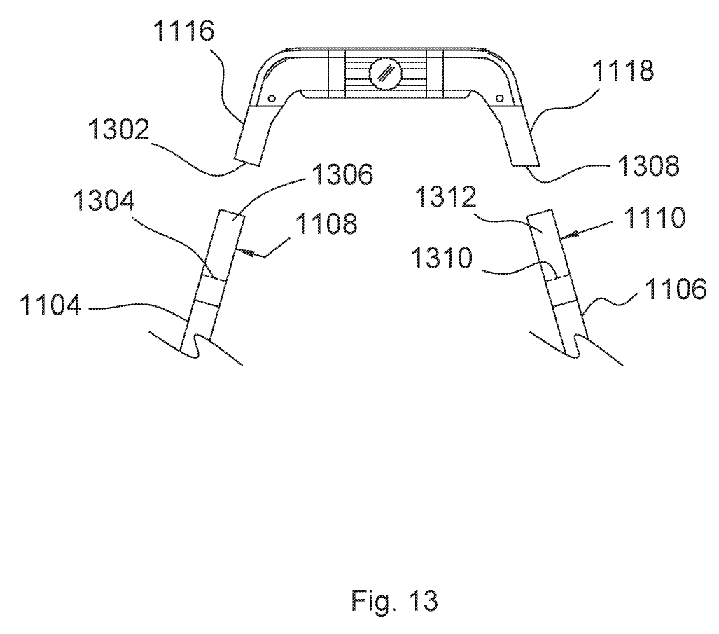

FIG. 13 shows an exploded side view of a wrist watch device 1100 showing how the wrist strap portions 1104, 1106 attach to the body 1102 of the wrist watch device 1100, in accordance with some embodiments. First support member 1108 is coupled to the proximal end of the first wrist strap portion 1104, and forms a cavity 1306 therein. The first protrusion 1116 fits within the cavity 1306. Electrical contacts 1302 at the bottom of the first protrusion 1116 mate with contacts 1304 at the end side of the proximal end of the first wrist strap portion 1104. The first wrist strap portion 1104 can be held onto the body 1102 by, for example, opposing screws that couple to a threaded hole such as threaded hole 1303. Likewise, second protrusion 1118 fits into cavity 1312 of the second support member 1110 at the proximal end of the second wrist strap portion 1106. Electrical contacts 1308 at the bottom of the second protrusion 1118 mate with contacts 1310 at the end edge of the proximal end of the second wrist strap portion 1106.

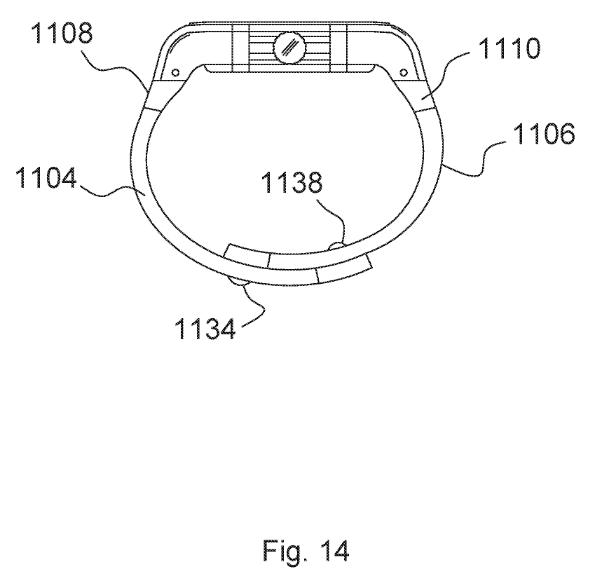

FIG. 14 shows a side view of a wrist watch device 1100 that shows how the wrist strap portions 1104, 1106 are retained when worn by a user, in accordance with some embodiments. Retaining protrusions 1134 of the second wrist strap portion pass through holes in the first wrist strap portion, and retaining protrusions 1138 of the first wrist strap portion 1104 pass through holes in the second wrist strap portion 1106. The material of the wrist strap portions 1104, 1106 in which the retaining holes are located is a flexible or compliant material that is deformable and which tends to return to its original shape. The retaining protrusions 1134, 1138 are generally post-like with a cross sectional diameter that is the same size as the diameter of the retaining holes. However, the ends of the retaining protrusions 1134, 1138 are slightly enlarged, having a cross sectional diameter that is slightly larger than the diameter of the retaining holes so that, upon passing through the retaining holes, the retaining protrusions are retained by interference.

A wrist watch device has been disclosed that includes a time keeping circuit powered by a first or primary battery cell, and which further includes a secondary battery capable of recharging the battery of a portable electronic device, such as a cellular telephone device. The secondary battery is charged through a connector disposed at the distal end of the first wrist strap portion, by, for example, connecting to a power source (e.g. computer, power converter). The secondary battery can be used to recharge the battery of the portable electronic device through a connector at the distal end of the second wrist strap portion, is configured to mate with the power/data connector of the portable electronic device. Accordingly, the wrist watch device solves the problem of having to either carry a bulky external battery pack or a plug-in charger when travelling in order to recharge a portable electronic device. Integrating the secondary battery into the watch device allow the user to have an emergency power source in the event the battery of the user's phone, for example, become discharged, and the user does not have a separate battery power pack or power converter. The watch is small enough to be convenient to wear, and yet large enough to house a secondary battery that can provide a substantial charge.

What is claimed is:

1. A wrist-worn watch device, comprising:
a body including an internal volume and an external face, a visual time keeping indicator disposed at the external face that is controlled by a time keeping circuit disposed in the internal volume of the body;
a primary battery disposed in the internal volume of the body that exclusively powers the time keeping circuit;
a secondary battery disposed in the internal volume of the body;
a non-volatile memory disposed in the internal volume of the body;
a first wrist strap portion that is coupled to the body at a proximal end of the first wrist strap portion by a first coupling, the first wrist strap portion including a first electrical connector having a first mechanical arrangement that is disposed at a distal end of the first wrist strap portion that is electrically connected to the non-volatile memory and the secondary battery through the first coupling; and
a second wrist strap portion that is coupled to the body at a proximal end of the second wrist strap portion by a second coupling, the second wrist strap portion including a second electrical connector having a second mechanical arrangement that is disposed at a distal end of the second wrist strap portion that is electrically connected to the non-volatile memory and the secondary battery through the second coupling.

2. The wrist-worn watch device of claim 1, further comprising:
a pair of retaining pins extending perpendicularly from the first wrist strap portion at the distal end on an inward-facing side of the first wrist strap portion; and
the second wrist strap portion having a plurality of retaining holes arranged along a length of the second wrist strap portion configured to receive and retain the pair of retaining pins at an outward-facing surface of the second wrist strap portion.

3. The wrist-worn watch device of claim 1, wherein the first connector is a micro-USB B-plug connector.

4. The wrist-worn watch device of claim 1, wherein the first connector and second connector have different mechanical and electrical arrangements.

5. The wrist-worn watch device of claim 1, wherein the non-volatile memory comprises removable memory card.

6. The wrist-worn watch device of claim 1, further comprising a solar power source that provides electric power only to the time keeping circuit and primary battery.

7. The wrist-worn device of claim 1, wherein first coupling comprises a first protrusion at a first end of the body that fits within a cavity formed by a first support member at the proximal end of the first wrist strap portion, and the second coupling comprises a second protrusion at a second end of the body that fits within a cavity formed by a second support member at the proximal end of the second wrist strap portion.

8. The wrist-worn device of claim 7, wherein a plurality of electrical contacts are disposed at a bottom of each of the first and second protrusions at the first and second ends, respectively of the body, and wherein the plurality of contacts of the first protrusion mate with a corresponding contact on an end of the first wrist strap portion and the plurality of contacts of the second protrusion each mate with corresponding contact on an end of the second wrist strap portion.

9. A watch device, comprising:
a body including a time keeping circuit that is powered by a primary battery, and a secondary battery that is rechargeable;
a first wrist strap portion having a first connector at a distal end of the first wrist strap portion that is configured to receive a charging current from a power source to recharge the secondary battery; and
a second wrist strap portion having a second connector at a distal end of the second wrist strap portion that is configured to provide a charging current from the secondary battery to a portable electronic device.

10. The watch device of claim 9, wherein the first connector is configured as a universal serial bus connector.

11. The watch device of claim 9, further comprising, a memory card device that is mounted inside the body, and is accessible via at least the first connector.

12. The watch device of claim 9, wherein:
the first wrist strap portion includes a plurality of conductors disposed inside the first wrist strap portion that connect the first connector at the distal end of the first wrist strap portion to the body; and
the second wrist strap portion includes a plurality of conductors disposed inside the second wrist strap portion that connect the second connector at the distal end of the second wrist strap portion to the body.

13. the watch device of claim 9, wherein the body further comprises first and second protrusions disposed, respectively, at first and second ends of the body, and which each include an electrical connector that mates with a corresponding electrical connector at a proximal end of the first and second wrist strap portions, respectively.

14. The watch device of claim 9, further comprising:
a first cover at the distal end of the first wrist strap portion that is configured to selectively cover or expose the first connector; and
a second a first cover at the distal end of the second wrist strap portion that is configured to selectively cover or expose the second connector.

15. The watch device of claim 14, wherein:
the first cover comprises at least one retaining protrusion configured to mate with, and be retained in one of a plurality of retaining holes formed in the second wrist strap portion; and
the second cover comprises at least one retaining protrusion configured to mate with, and be retained in one of a plurality of retaining holes formed in the first wrist strap portion.

16. The watch device of claim 9, further comprising a solar power source disposed in the body that is configured to provide electric power to the primary battery.

17. A watch device, comprising:
a body;
a time keeping circuit disposed in the body;
a time indicator disposed on a face of the body and that is operated by the time keeping circuit that indicates a time of day;
a primary battery disposed in the body that provides electric power to the time keeping circuit;
a secondary battery disposed in the body that is not electrically coupled to the time keeping circuit;
a memory device disposed in the body;
a first wrist strap portion connected to the body at a first end of the body such that a plurality of electrical contacts at a proximal end of the first wrist strap portion mate with a corresponding plurality of electrical contacts at the first end of the body, the first wrist strap portion further having a first connector at a distal end of the first wrist strap portion that is electrically connected to the secondary battery and memory device through the plurality of electrical contacts at the first end of the body and through which the secondary battery is recharged; and
a second wrist strap portion connected to the body at a second end of the body such that a plurality of electrical contacts at a proximal end of the second wrist strap portion mate with a corresponding plurality of electrical contacts at the second end of the body, the second wrist strap portion further having a second connector at a distal end of the second wrist strap portion configured to connect to a portable electronic device and that is electrically connected to the secondary battery and memory device through the plurality of electrical contacts at the second end of the body and through which the secondary battery recharges a battery of the portable electronic device.

18. The watch device of claim 17, further comprising
a first cover at the distal end of the first wrist strap portion that is configured to selectively cover or expose the first connector; and
a second a first cover at the distal end of the second wrist strap portion that is configured to selectively cover or expose the second connector.

19. The watch device of claim 15, wherein:
the first cover comprises at least one retaining protrusion configured to mate with, and be retained in one of a plurality of retaining holes formed in the second wrist strap portion; and
the second cover comprises at least one retaining protrusion configured to mate with, and retained in one of a plurality of retaining holes formed in the first wrist strap portion.

20. The watch device of claim 16, wherein the first connector is configured as a universal serial bus connector.
